(19) United States
(12) Patent Application Publication
(10) Pub. No.: US 2004/0227676 A1
(43) Pub. Date: Nov. 18, 2004

(54) Antenna for cellular phone

(76) Inventors: Youn-Sung Kim, Bucheon (KR); Kwang Jae Cho, Hongsung-gun (KR)

Correspondence Address: Ladas & Parry, 26 West 61st Street, New York, NY, 10023, US

(21) Appl. No.: 10/785,801

(22) Filed: Feb. 24, 2004

(30) Foreign Application Priority Data
May 16, 2003 (KR) 10-2003-0031332
Nov. 27, 2003 (KR) 10-2003-0085275

(51) Int. Cl. H01Q 1/24

(52) U.S. Cl. 343/702

(57) ABSTRACT

The present invention relates to an antenna for a cellular phone that is always installed in the same construction irrespective of an outer look of an antenna when the antenna is engaged to a cellular phone body, and is stably fixed to a cellular phone body, and an assembling and disassembling procedure are easy, and an antenna exchanging operation is conveniently performed. The antenna for a cellular phone comprises an antenna holder having a guide groove part and engaged in a body of a cellular phone; an antenna housing that is formed of an antenna connector having a protrusion part engaged to the guide groove part and fixedly inserted into the antenna holder, and an antenna support part integrally formed in the antenna connector; and a rod antenna that passes through the antenna connector and the antenna support part, respectively, in such a manner that the rod antenna is extendable from the body of the cellular phone.

### BACKGROUND OF THE INVENTION

1. Field of the Invention

The present invention relates to an antenna for a cellular phone, and in particular to an antenna for a cellular phone that is stably fixed to a body of a cellular phone wherein assembling and disassembling procedures are easy for thereby achieving an easier maintenance.

2. Description of the Background Art

Generally, a cellular phone is an apparatus so that people can freely communicate based on a wireless communication technology while people are moving. Here, there are various kinds of communication devices such as a cellular phone, a PCS phone, a digital phone, etc.

The cellular phone includes an antenna for a signal transmission and receiving operation. The antenna of the cellular phone is generally classified into a fixed type antenna of which the length is not changed because it is fixed to the body of the cellular phone, and an extendable antenna in which a rod antenna is extended and contracted from an antenna housing fixed to the body of the cellular phone. W/hen designing the cellular phone, one between the fixed antenna and the extendable antenna is selected based on the function and design.

FIG. 1 is a perspective and partial cross sectional view illustrating a conventional antenna of a cellular phone.

As shown therein, in the cellular phone 1 having an extendable antenna, an antenna 10 includes an antenna housing 11 protruded from an upper side of a lower frame 14a of a cell phone body 14, a rod antenna 15 extended or contacted into the housing 11, and an antenna holder 16 installed within the upper side of the lower frame 14a of the cell phone body 14.

A metallic antenna holder 16 is installed in the upper side of the lower frame 14a of the cell phone body 14, wherein the antenna holder 16 is connected with a transmission and receiving circuit (not shown) of the cell phone body 14 for thereby receiving signals. The antenna housing 11 includes an antenna support part 12 having a circular cross section, and a metallic antenna connector 13 integrally formed in the lower side of the same. A threaded part 13a is formed in an outer side of the antenna connector 13. The antenna housing 11 is fixed to the cell phone body 14 in such a manner that the threaded part 13a of the antenna connector 13 is threaded to the antenna holder 16.

The rod antenna 15 vertically passes through the antenna housing 11 and is extendable through the same. When the rod antenna 15 is upwardly extended, a contacting part (not shown) of the lower end portion of the rod antenna 15 contacts with the antenna connector 13 and is electrically connected with the body transmission and receiving circuit (not shown) for thereby achieving signal transmission and receiving operations.

When repairing the antenna in the case that the rod antenna 15 is broken, the antenna housing 11 is rotated, and the antenna housing 11 is separated from the cell phone body 14, and a new unit formed of the rod antenna 15 and the antenna housing 11 is assembled easily.

In order to meet user's various demands, the shape of the cross section of the antenna housing may be diversified. The cross section may be formed in a rectangular shape, a diamond shape, an elliptical shape, etc.

FIG. 2 is a perspective and partial assembling view illustrating a conventional antenna of a cellular phone.

In the cellular phone 2 adapting an extendable antenna as another example of the conventional art, as shown in FIG. 1, the antenna 20 includes an antenna housing 21 protruded from an upper side of the lower frame 27a of a cellular phone body 27, a rod antenna 25 extendable from the housing 21, and an antenna holder (not shown) installed in the upper side of the body lower frame 27a.

Here, the antenna housing 21 includes an antenna support part 22 having a rectangular cross section, and a metallic antenna connector 23 integrally formed in a lower side of the antenna support part 22. As shown in FIG. 1, the antenna connector is formed in a cylindrical shape and has a threaded part in an outer side. The antenna connector 23 is formed in an edge shaped engaging structure and is engaged to the cellular phone body 27 by an edge engaging method.

When the antenna connector 23 is formed in a cylindrical shape and has a threaded part in an outer side of the same, the construction that the antenna housing 21 is engaged to the cellular phone body 27 is changed based on an engaged state of the antenna support part 22 and the antenna connector 23. Namely, when viewing front side of the cellular phone, the antenna housing 21 may be viewed in a twisted shape. The above outer look is not good. Therefore, in the antenna having a certain cross section that is not a circular shape, there is a design limit that the antenna connector should be fabricated in an edge shape.

In the conventional antenna having the above construction, when the rod antenna is broken due to an external, impact, the repairing operation of the antenna is performed through a very complicated procedure. Namely, in the repairing operation of the antenna 20, the battery pack 26 is first removed, and the lower frame 27a of the cellular phone body 27 is disassembled. The edge shaped antenna connector 23 positioned in the inner side of the cellular phone body 27 is exposed to the outside, and then the antenna 20 is exchanged.

However, the lower frame 27a and the upper frame 27b are engaged by various bolts (not shown) and protect various electronic parts such as a transmission and receiving circuit (not shown) installed in the interior of the cellular phone body 27, so that it is impossible for user to easily disassemble the parts. Therefore, the user pays additional repairing charges to a service center. When the service man repairs, since the service man must perform complicated works, a second error may occur in various connection apparatuses of the transmission and receiving circuit and the cellular phone.

In order to overcome the above described problems, according to the Korean laid-open utility model Nos. 2000-14202 and 2000-14216, even when a bending problem occurs in the antenna housing due to an external impact, a buffering groove is formed in the antenna holder for preventing the antenna from being escaped from the cellular phone body or from being damaged. In another example, the antenna holder is integrally formed in the cellular phone body. However, in the above cases, since it is impossible to exchange the antenna by an easier method, the above prior art fails to suggest a proper solution.

### SUMMARY OF THE INVENTION

Accordingly, it is an object of the present invention to provide an antenna for a cellular phone that is stably fixed to a cellular phone body, and an assembling and disassembling procedure are easy, and an antenna exchanging operation is conveniently performed.

It is another object of the present invention to provide an antenna for a cellular phone that is always installed in the same construction irrespective of an outer look of an antenna when the antenna is engaged to a cellular phone body, and various designs of antenna may be selected for thereby enhancing a function and outer look of the cellular phone.

To achieve the above objects, in the present invention, a protrusion part is formed in an antenna connector for supporting a rod antenna, and the protrusion part is inserted into a guide groove part of the antenna holder inserted into the interior of the body of the cellular phone. The antenna is conveniently engaged or disassembled from the body of the cellular phone by rotating the antenna housing.

To achieve the above objects, there is provided an antenna for a cellular phone, comprising an antenna holder having a guide groove part and engaged in a body of a cellular phone; an antenna housing that is formed of an antenna connector having a protrusion part engaged to the guide groove part and fixedly inserted into the antenna holder, and an antenna support part integrally formed in the antenna connector; and a rod antenna that passes through the antenna connector and the antenna support part, respectively, in such a manner that the rod antenna is extendable from the body of the cellular phone.

In addition, the antenna holder includes a guide groove part formed of an entry groove formed in a hollow cylindrical shape in such a manner that the protrusion is inserted into one side of an upper hole; an entry straight line groove horizontally extended from the entry groove; a slant guiding groove downwardly extended from the entry straight line groove; and a fixed straight line groove horizontally extended from the slant guiding groove.

Two guide groove parts are formed in the antenna holder, and two protrusion parts engaged with the guide groove part are formed in the antenna connector.

An elastic protrusion is formed in a lower side of the antenna support part of the antenna housing, and the elastic protrusion part contacts with an outer side of the body of the cellular phone, so that the antenna housing is stably fixed to the body of the cellular phone.

A fixed groove is formed in the fixed straight line groove of the guide groove part of the antenna holder wherein the protrusion part of the antenna connector is fixedly inserted into one of the fixed groove.

To achieve the above objects, in an antenna for a cellular phone that includes an antenna housing formed of a metallic antenna connector electrically connected with a transmission and receiving circuit in the interior of a body of a cellular phone and having a vertical through hole in the interior of the body so that a rod antenna is upwardly expendable, and an antenna support part that is formed of a synthetic resin or rubber material and integrally formed in an outer side of the antenna connector by an insert injection method so that a cross sectional shape is line-symmetrical line an elliptical shape or a rectangular shape, an antenna engaging part formed in one side of the upper side of the body so that the antenna housing is engaged to the body of the cellular phone, and a metallic antenna holder installed in a hollow mounting groove formed in the antenna engaging part, there is provided an improved antenna for a cellular phone, comprising a protrusion step vertically formed in the upper side of the antenna holder at both sides of the same in such a manner that a downwardly slanted groove is formed from one side to the other side or from the other side to one side, wherein the antenna holder is installed in the mounting groove in such a manner that an extension line connecting both protrusion steps is horizontal with respect to the upper surface of the body of the cellular phone; and a stopper provided at both sides of the outer wall of the antenna connector and engaged with the protrusion step, wherein both ends of the antenna support part are horizontal with respect to the upper surface of the body of the cellular phone and are matched with the upper surface of the antenna engaging part.

The height of the protrusion step is within a range of 0.2 mm through 1 mm.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view of an antenna for a cellular phone and a partial cross sectional view of an antenna in a conventional art;

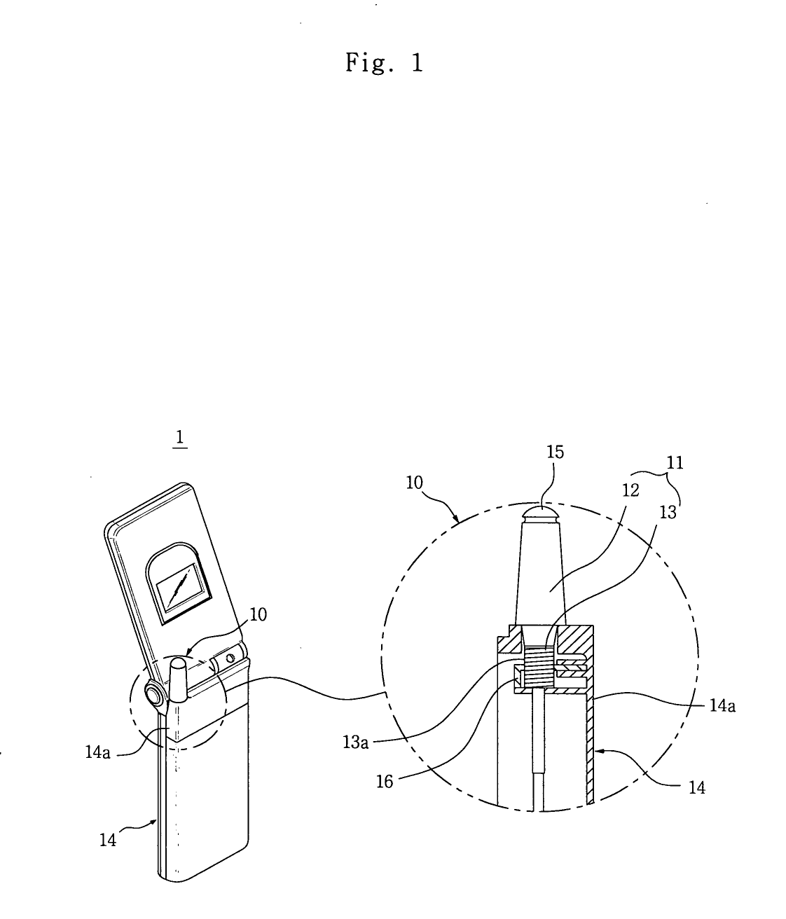

FIG. 2 is a perspective view of an antenna for a cellular phone and a partial assembling view of the same in another conventional art;

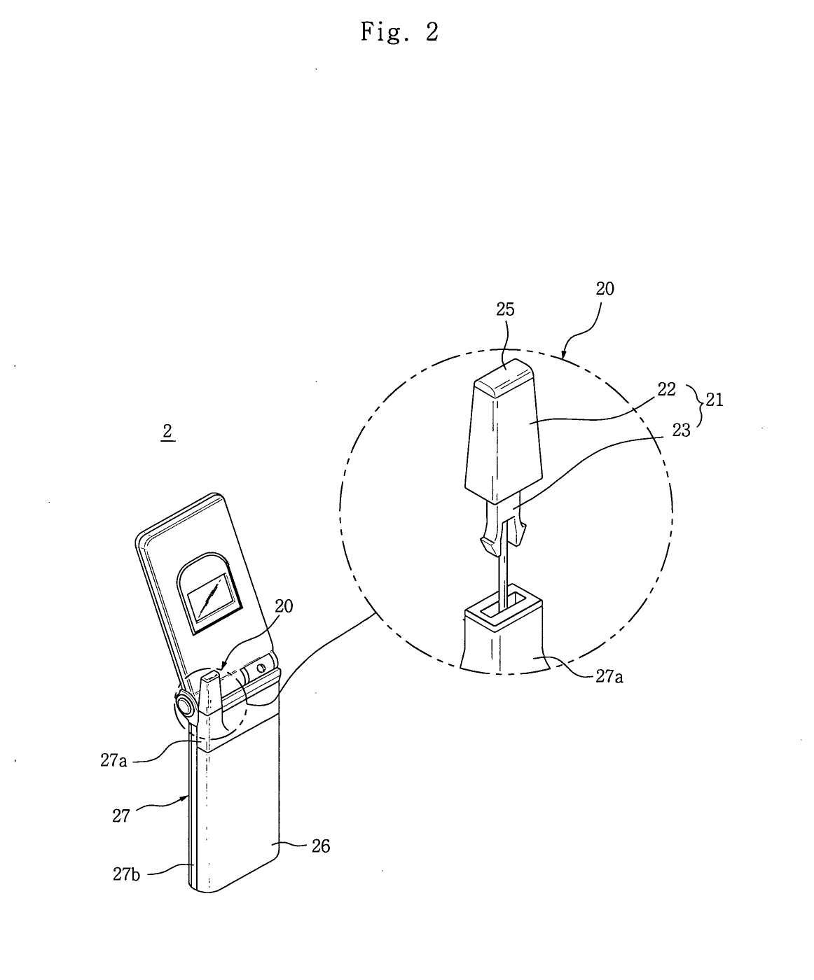

FIG. 3 is a perspective view of an antenna of a cellular phone and a partial cross sectional view of the same according to a first embodiment of the present invention;

FIG. 4 is a disassembled perspective view of an antenna for a cellular phone according to a first embodiment of the present invention;

FIG. 5 is a disassembled perspective view of an antenna holder and an antenna according to a first embodiment of the present invention;

FIG. 6 is a disassembled perspective view of an antenna holder and an antenna according to a second embodiment of the present invention;

FIG. 7 is a partial cross sectional view illustrating an antenna engaging part according to a third embodiment of the present invention;

FIG. 8 is a disassembled perspective view of an antenna connector and an antenna holder according to a third embodiment of the present invention;

FIG. 9 is a partial cross sectional view illustrating an antenna engaging part according to a fourth embodiment of the present invention;

FIG. 10 is a partial enlarged view illustrating an antenna connector engaging part according to a fourth embodiment of the present invention;

FIG. 11 is a disassembled perspective view illustrating an antenna connector and an antenna holder according to a fifth embodiment of the present invention;

FIG. 12 is a partial cross sectional view illustrating an antenna engaging part according to a fifth embodiment of the present invention;

FIG. 13 is a partial enlarged view illustrating an antenna engaging part according to a fifth embodiment of the present invention; and

FIG. 14 is a perspective view illustrating the state of use of an antenna according to a fifth embodiment of the present invention.

### DETAILED DESCRIPTION OF THE PREFERRED EMBODIMENTS

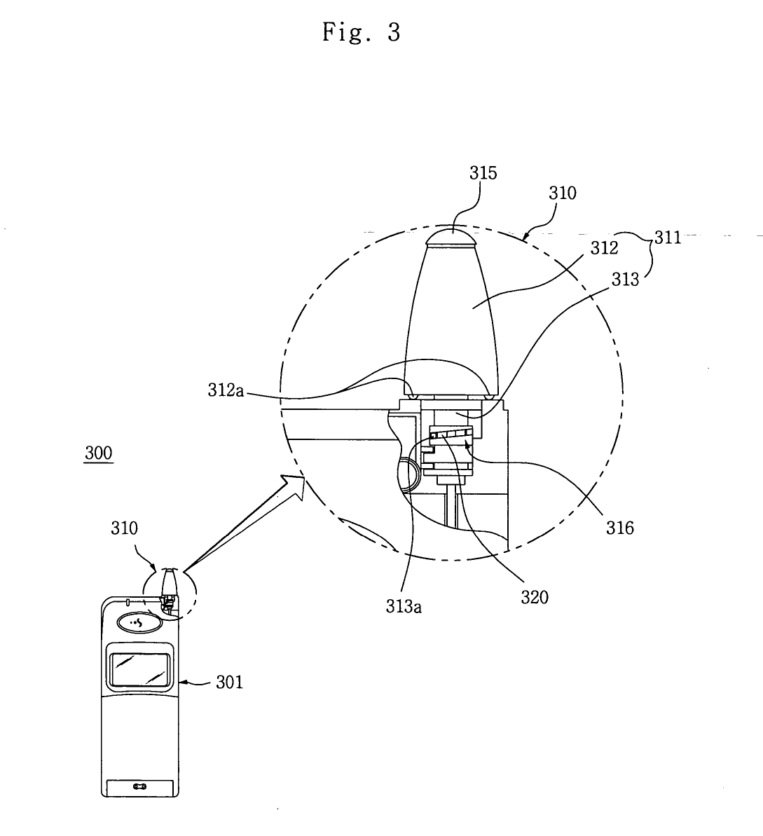

As shown in FIG. 3, the antenna 310 for a cellular phone according to a first embodiment of the present invention is installed at a certain portion of a body 301 of a cellular phone 300 wherein a rod antenna 315 is extendable in an upward direction of the body 301.

The antenna 310 includes an antenna holder 316 installed in the cellular phone body 301, an antenna housing 311 engaged to the antenna holder 316, and a rod antenna 315 passing through the antenna housing 311.

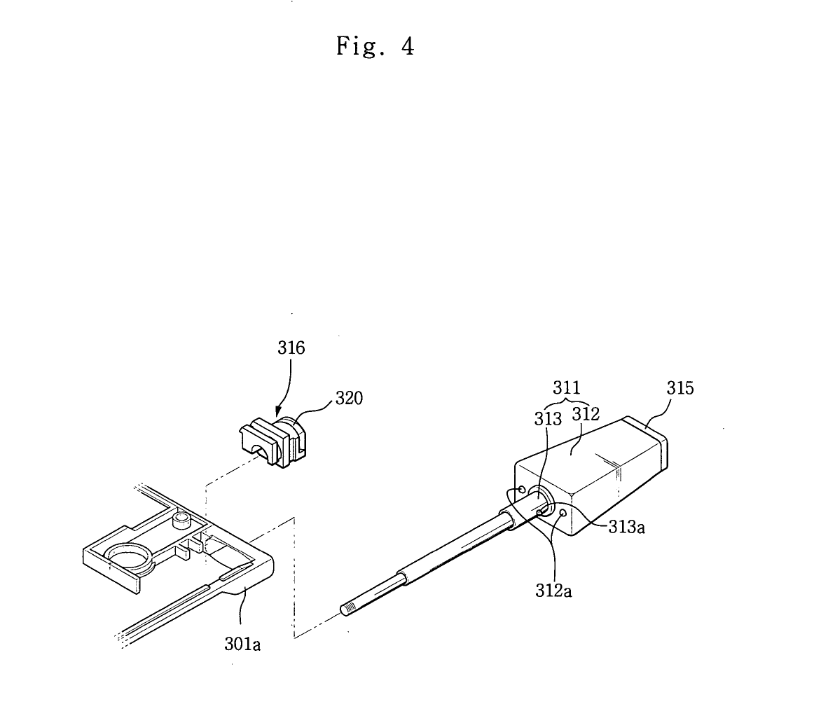

As shown in FIG. 4, the antenna holder 316 is formed in a metallic hollow cylindrical shape and includes a guide groove part 320 in a wall surface and is engaged to a lower frame 301a of the body 301 and is connected with a transmission and receiving circuit (not shown) of the body 301 for thereby performing a signal transmitting and receiving operation.

The antenna housing 311 includes an antenna support part 312 having a rectangular cross section, and an antenna connector 313 integrally formed in the support part 312. The antenna part 312 is formed of an electrically insulated material and is integrally formed in the metallic antenna connector 313 by an injection method. The antenna support part 312 may have a rectangular cross section and may have a certain cross section shape such as a diamond shape, an elliptical shape etc. in consideration with the entire design of the cellular phone.

The antenna housing 311 engaged with the support part 312 and the antenna connector 313 has a through hole (not shown) in a vertical direction, and a rod antenna 315 passes through the through hole based on a sliding movement method. An elastic protrusion part 312a contacting with the body 301 is formed in a lower side of the support part 312, so that the antenna housing 311 is stably fixed with respect to the body 301.

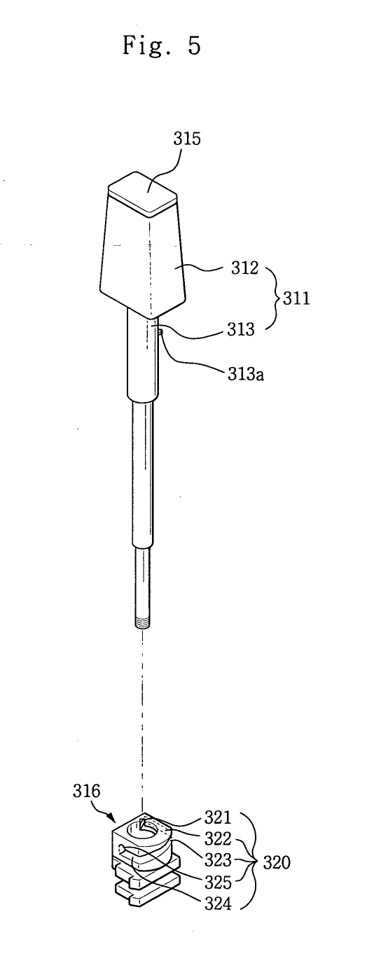

As shown in FIG. 5, a protrusion part 313a is formed in an outer side of the antenna connector 313 and is engaged with a guide groove part 320 of the antenna holder 316. The protrusion part 313a is moved through the guide groove part 320 and is fixed as the antenna housing 311 is rotated, so that the antenna housing 311 is stably fixed.

The rod antenna 315 vertically passes through the antenna housing 311 and is installed in such a manner that it is extendable and contracted. When it is extended in the upward direction, the contacting part (not shown) of the lower end of the rod antenna 315 contacts with the antenna connector 313, so that an electrical connection with the transmission and receiving circuit (not shown) of the body is implemented through the antenna holder 316 for thereby performing a signal transmission and receiving operation.

The guide groove part 320 is formed of a plurality of grooves formed in the wall surface of the antenna holder 316. Namely, the guide groove part 320 includes an entry groove 321 formed in an outer portion of the upper-hole of the antenna hole 316 so that the protrusion part 313a is inserted, an entry straight line groove 322 horizontally extended from the entry groove 321, a slant guiding groove 323 extended in the lower direction from the entry straight line groove 322 at a certain inclination angle, a fixed straight line groove 324 horizontally extended from the slant guiding groove 323, and a fixed groove 325 formed in the end portion of the fixed straight line groove 324.

The operation that the protrusion part 313a is moved along the guide groove part 320, and the antenna housing 311 is fixed to the body 301 will be described.

The entry groove 321 operates as a path that the protrusion part 313a is inserted. The entry straight line groove 322 guides the protrusion part 313a to move in the direction of the slant guiding groove 323 as the antenna housing 311 is rotated.

When the protrusion part 313a is moved into the slant guiding groove 323, the elastic protrusion part 312a of the lower side of the antenna support part 312 contacts with the upper side of the body 301, so that the gap between the antenna housing 311 and the body 301 is decreased. At this time, the antenna holder 316 is pulled in the direction of the antenna housing 311 based on the construction of the slant guiding groove 323 in which a slant is formed in the axial direction of the antenna holder 316.

When the antenna housing 311 is rotated more, the protrusion part 313a is slid into the fixed straight line groove 324, so that the antenna housing 311 is fixed to the body 301, and the protrusion part 313a is inserted into the fixing groove 325. In the above state, it is inserted into a deeper portion in the direction of the antenna holder 316 as compared to when the protrusion part 313a is positioned in the entry groove 321 based on the construction of the slant guiding groove 323. The antenna holder 316 and the antenna housing 311 strongly pull each other based on the operation of the elastic protrusion part 312a. Therefore, since the protrusion part 313 maintains a stably inserted state into the fixing groove 325, the antenna housing 311 is stably fixed in the body 301.

When the antenna 310 is installed in the body 301 of the cellular phone 300 in the above described manner, since the position of the installation is determined based on an operation between the guide groove part 320 and the protrusion part 313a, the antenna 310 is installed in the body always in the same construction irrespective of the construction of the antenna housing 311.

In the thusly constituted antenna, when the rod antenna 315 is damaged by an external impact, the fixing work for exchanging the antenna is performed by an easier method.

When rotating the antenna housing 311 for exchanging the antenna 310, the protrusion part 313a is escaped from the fixing groove 325-and the fixed straight line groove 324, and the antenna housing 311 and the body 301 are disengaged. When the antenna housing 311 is more rotated, it is possible to fully separate the antenna 310 from the body 301.

Therefore, it is possible to assemble and disassemble the antenna 310 based on the above described easier procedure, and the user can easily repair without paying additional charges. In addition, it is possible to avoid the second error that may occur in the transmission and receiving circuit and various connection apparatuses in the cellular phone during the complicated repairing procedures.

In the first embodiment of the present invention, since only one protrusion part and one guide groove part are provided, so that the antenna housing 311 is rotated at about 180° with respect to the body 301 for thereby implementing an engaging operation.

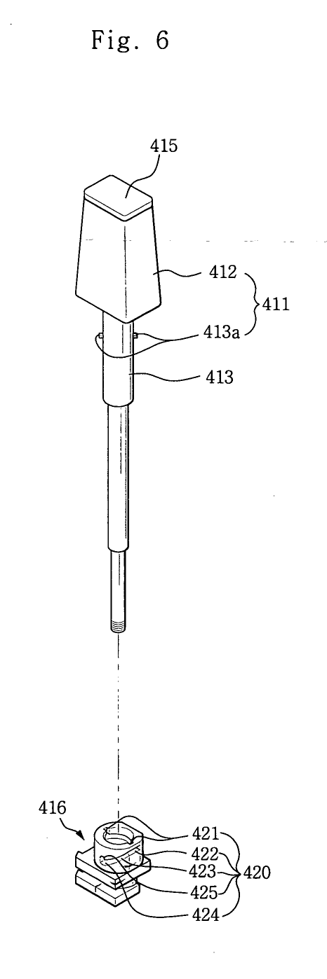

As shown in FIG. 6, in the second embodiment of the present invention, two guide groove parts 420 are symmetrically provided in the antenna holder 416. Two protrusion parts 413a are provided in the antenna connector 413. Each protrusion part 413a is engaged to the guide groove part 420, so that the antenna housing 411 is fixed to the body. In the drawings, reference numeral 415 represents a rod antenna, and 412 represents an antenna support part.

The guide groove part 420 includes an entry groove 421, an entry straight line groove 422, a slant guide groove 423, a fixed straight line groove 424 and a fixed groove 425. Namely, the construction of this embodiment is similar with the construction of the second embodiment of the present invention. However, in the second embodiment of the present invention, the entire length of the guide groove part 420 is different from that of the first embodiment of the present invention. However, the entire length of the guide groove part 420 is different from the first embodiment of the present invention. Namely, two guide groove parts 420 are symmetrically formed on the antenna holder 416. However, the operations of each groove are the same as the operation of each groove of the guide groove part 320 according to the first embodiment of the present invention.

The protrusion part 413a is engaged to the guide groove part 420 and is inserted into the fixed groove 425 as the antenna housing 411 is rotated at about 90°, so that the antenna housing 411 and the body are more stably fixed.

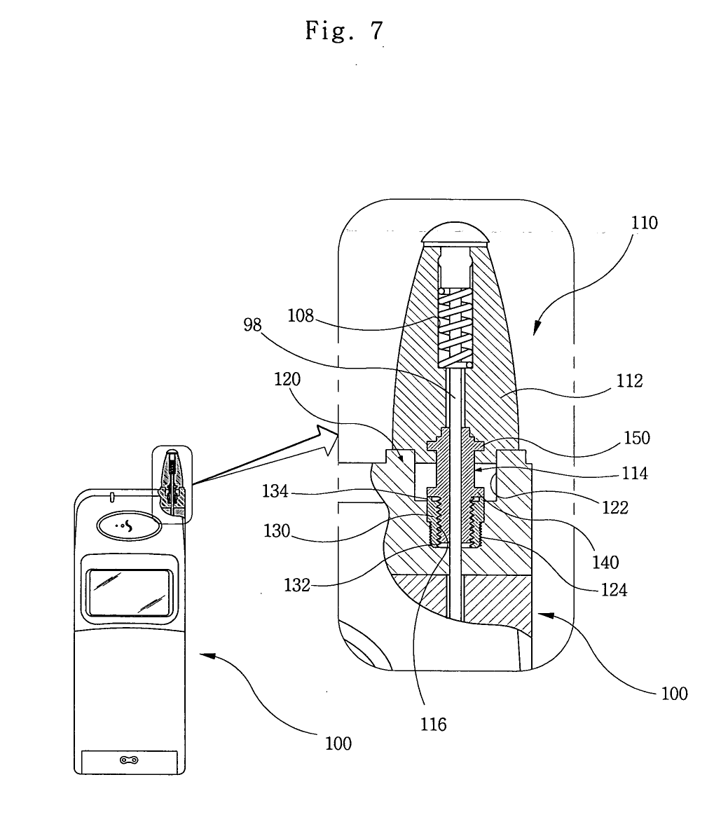

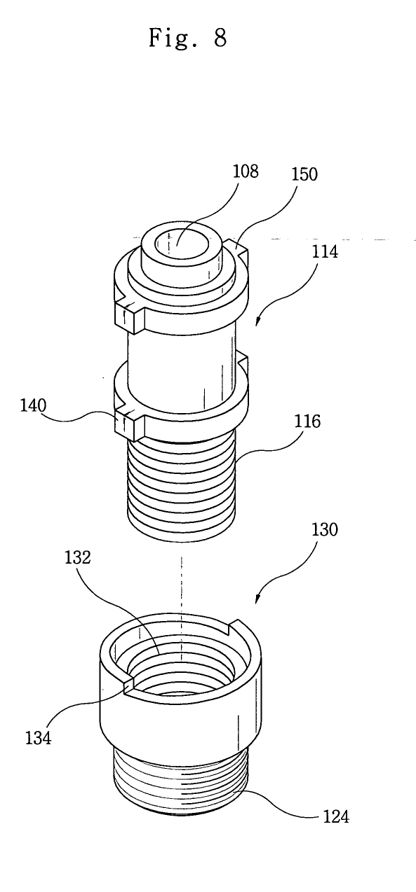

As shown in FIGS. 7 and 8, in the third embodiment of the present invention, the rod antenna 98 is extendable from the upper side of the body 100. The antenna housing 110 having the through hole 108 formed in the vertical direction is threaded to the body 100 of the cellular phone in a state that the antenna housing 110 is protruded at a certain height at the upper side of the body 100. The antenna housing 110 includes a molded synthetic antenna support part 112, and a metallic antenna connector 114 electrically connected with the transmission and receiving circuit (not shown) of the cellular phone.

In the drawings, the cross section of the antenna support part 112 is seen in an elliptical shape. The shape of the cross section of the same may be a diamond shape or an elliptical shape.

The antenna connector 114 is formed in a cylindrical shape, so that the rod antenna 98 passes through, and a threaded part 116 is formed in the lower outer wall side for engaging the antenna housing 110 to the body 100 of the cellular phone. In the interior of the antenna connector 114, there is provided an inwardly supported elastic member (not shown) for stably supporting the rod antenna 98 when it is extended, and for maintaining a stable electrical connection with the lower side of the rod antenna 98. On the contrary, an elastic member(not shown) may be outwardly supported in the lower side of the rod antenna 98 instead the elastic member is installed in the interior of the antenna connector 114.

An antenna engaging part 120 is formed in one upper side of the body 100 of the cellular phone, and a hollow mounting groove 122 is formed in the interior of the antenna engaging part 120. A threaded portion is formed in the interior of the engaging groove 122, and an antenna holder 130 having an engaging threaded portion 124 formed in an outer portion is engaged. At this time, an insert injection may be formed together with the antenna holder 130 when molding the body 100 of the cellular phone instead the engaging threaded portion 124 is formed in an outer wall of the antenna holder 130.

The antenna holder 130 is formed in a hollow cylindrical shape and has a threaded groove 132 corresponding to the threaded portion 116 in the inner wall. A pair of protrusion steps 134 are vertically formed at the upper side opposite to the antenna connector 114 in the portion in which the slanted surfaces stop, by cutting the shoulder portions at a certain slanted angle.

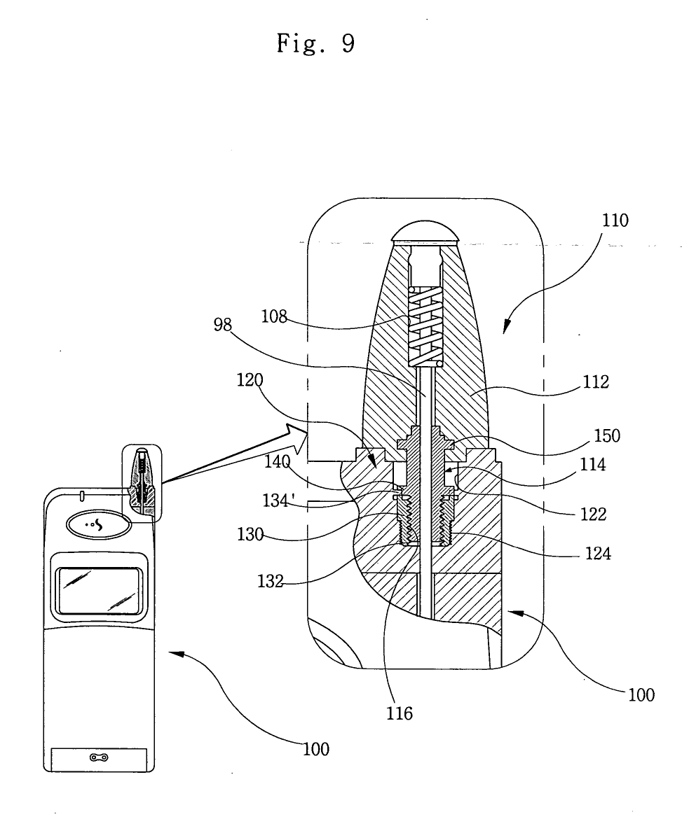

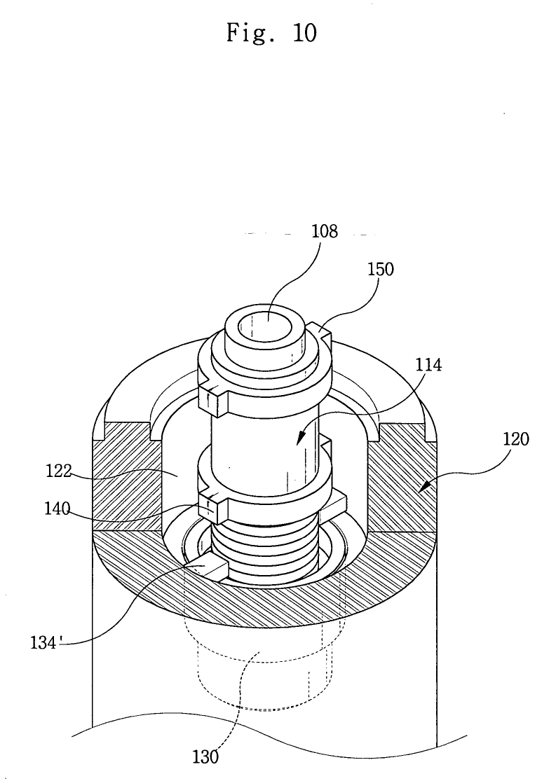

As shown in FIGS. 9 and 10, in the fourth embodiment of the present invention, a protrusion step 134′ may be formed in the inner wall of the mounting groove 122 instead the protrusion step 134 is formed in the antenna connector 114. At this time, the protrusion step 134′ is integrally formed when injecting the body of the cellular phone using synthetic resin like plastic.

In addition, a stopper 140 is formed in the outer wall of the circular antenna connector 114 for limiting the rotation of the antenna connector 114 in such a manner that it is engaged with the protrusion step 134. Therefore, the stopper 140 formed in the outer wall of the antenna connector 114 is engaged with the protrusion step 134 formed in the upper surface of the antenna holder 130, or the stopper 140 is engaged with the protrusion step 134′ formed in the inner wall of the mounting groove 122, so that the antenna connector 114 does not rotate. Therefore, the assembling direction of the antenna housing 110 is determined.

The protrusion steps 134, 134′ are adapted to limit the rotation of the antenna connector 114 and perform a function for determining the assembling direction of the antenna housing 110. The heights and thickness of the protrusion steps 134,134′ are preferably small within a range of 0.2 mm to 1 mm.

Two engaging shoulder portions 150 are formed in the upper side of the antenna connector 114 in the same as the stopper 140 or in a similar shape of the stopper 140. The engaging shoulder portions 150 perform the function of preventing the insert-molded antenna connector 114 from being idle-rotated with respect to the synthetic resin antenna support part 112. The assembling procedures of the antenna according to the third and fourth embodiments of the present invention will be described.

The assembling procedure according to the third embodiment of the present invention will be first described. The antenna holder 130 is engaged to the mounting groove 122 formed in the support member and is installed in such a manner that an extending line connecting the protrusion step 134 is matched with the upper surface of the body 100 of the cellular phone. The rod antenna 98 is inserted into the through hole 108, and an elastic member (not shown) is installed in the lower side of the rod antenna. The threaded portion of the antenna connector 114 is inserted into the upper side of the antenna holder 130 and is rotated in the clockwise direction, so that the antenna housing 110 is engaged to the body 100 of the cellular phone. At this time, it is rotated in the clockwise direction until the stopper 140 formed in an outer wall of the antenna connector 114 is caught by the protrusion step 134.

The assembling procedure of the fourth embodiment of the present invention will be described. When the antenna holder 130 is engaged to the mounting groove 122 formed in the interior of the antenna engaging part 120, the engaging threaded portion 124 is formed in an outer wall of the antenna holder 130 for thereby engaging the antenna holder 130 to the mounting groove 122. An insert molding may be performed when injecting and molding the body 100 of the cellular phone. In the present invention, since the protrusion step 134′ is formed in the inner wall of the mounting groove 122 for determining the assembling direction of the antenna connector 114, it is preferred that it is integrally molded when molding the body 100 of the cellular phone rather than the thread engagement achieved by forming the engaging screw 124.

In addition, in the protrusion step 134′, the extension line connecting the protrusion step 134′ is horizontally formed and matched with the upper surface of the body 100. The rod antenna 98 is inserted into the through hole 108, and the elastic member (not shown) is installed at the end of the rod antenna 98. The threaded portion 116 of the antenna connector 114 is inserted into the upper side of the antenna holder 130 and is rotated in the clockwise direction, so that the antenna housing 110 is engaged to the body 100. At this time, it is rotated in the clockwise direction until the stopper 140 formed in the outer wall of the antenna connector 114 is caught by the protrusion step 134′. The shape of the insert injected antenna support part 112 has a good look balance with the body 100 of the cellular phone.

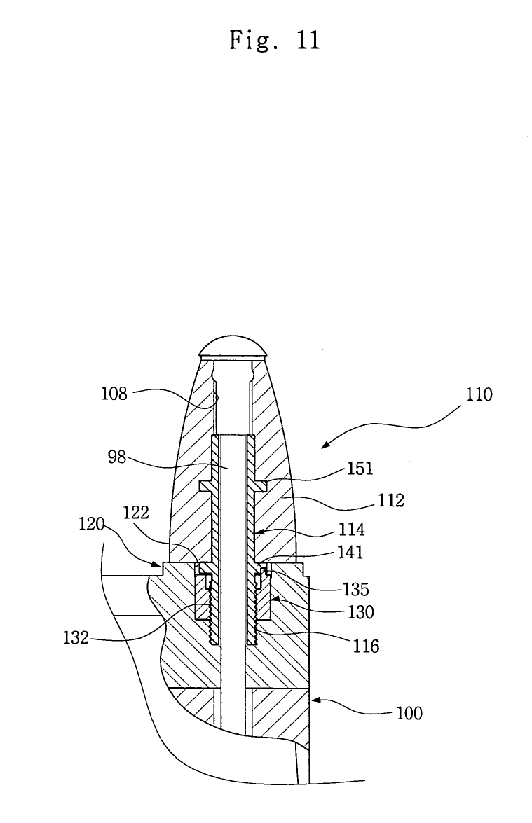

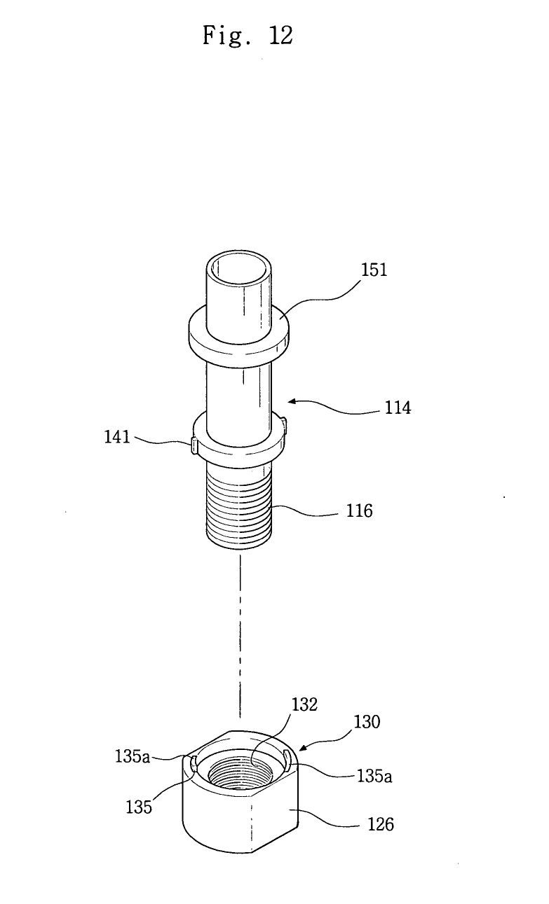

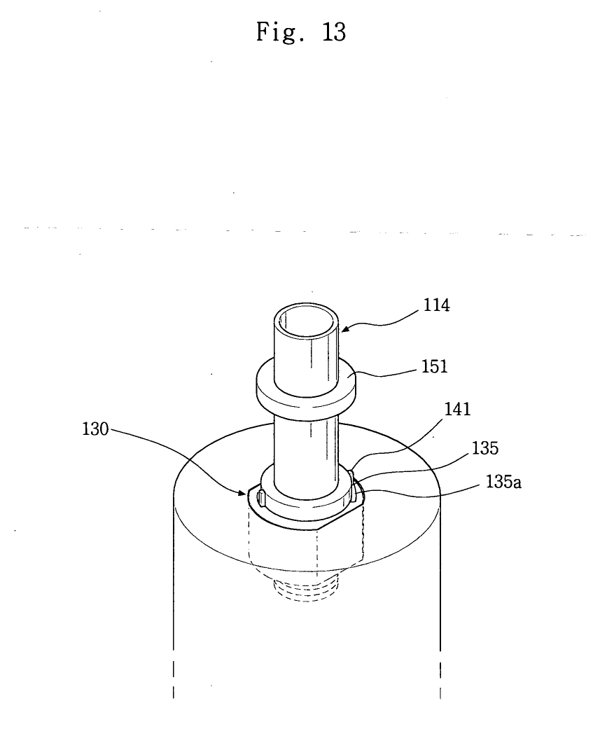

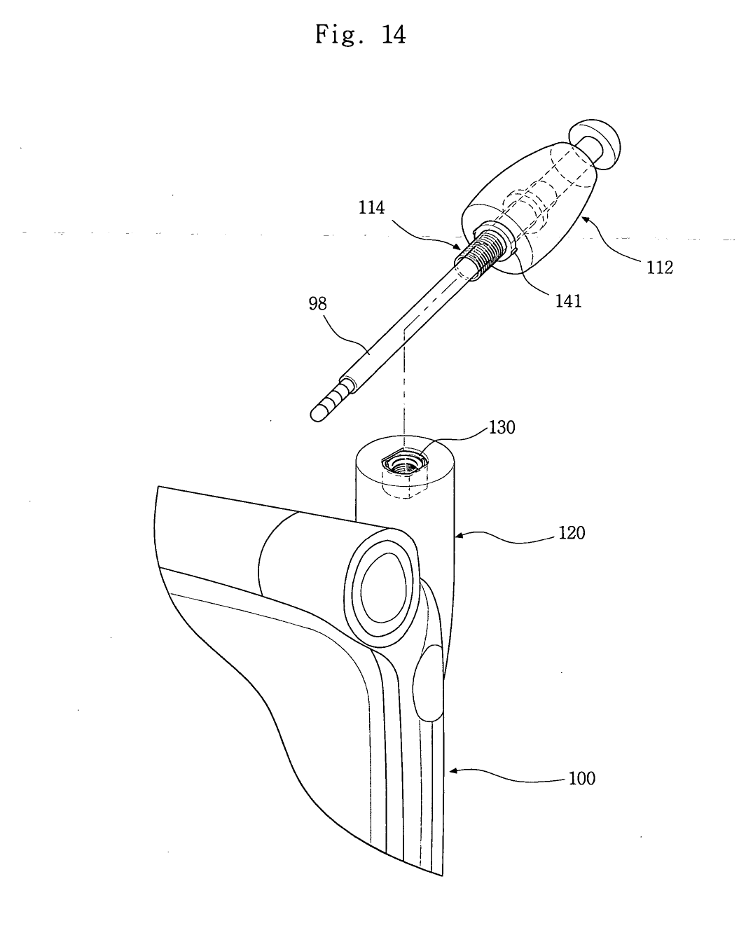

As shown in FIGS. 11, 12, 13 and 14 of the fifth embodiment of the present invention, the constructions of the protrusion step 135 formed in the antenna holder 130 and the stopper 141 formed in the antenna connector 114 are different from that of the third and fourth embodiments of the present invention.

Namely, the antenna engaging part 120 is formed in the upper side of the body 100 of the cellular phone, and a hollow mounting groove 122 is formed in the interior of the antenna engaging part 120 so that the antenna holder 130 is engaged thereinto. A rotation limit surface 126 formed of a straight surface is formed in the outer side of the antenna holder 130. Here, the inner wall of the mounting groove 122 is formed in a shape for accommodating the rotation limit surface 126 and has a function of limiting the rotation of the antenna holder 130. The antenna holder 130 is preferably inserted into the mounting groove 122 by a tight insertion method.

In addition, the protrusion step 135 formed in the upper side of the antenna holder 130 has a certain construction changed from the third and fourth embodiments of the present invention. In the third and fourth embodiments of the present invention, the slanted surfaces forming the protrusion steps 134, 134′ are formed along the upper outer surfaces of the antenna holder 130 in a longitudinal direction, and the ends of the slanted surfaces extended from the opposite protrusion steps 134, 134′ meet each other.

In the fifth embodiment of the present invention, the construction that the protrusion step 135 is vertically formed in the portion in which the slanted surface 135a formed in the upper side of the antenna holder 130 is downwardly slanted is similar with the constructions of the third and fourth embodiments of the present invention. However, in the fifth embodiment of the present invention, the slanted surface 135a is formed shorter as compared to the third and fourth embodiments in which the slanted surface 135a is formed longer, so that the end, in which the slanted surface 135a extended in the opposite direction of the protrusion step 135 stops, contacts with the upper surfaces of the antenna holder 130. Therefore, the ends of the slanted surface 135a extended from the opposite protrusion steps 135 do not meet each other.

The protrusion step 135 formed in the above described manner is adapted to guide the movement of the antenna connector so that the antenna connector 114 is smoothly engaged with the antenna holder 130.

The antenna connector 114 is formed in a cylindrical shape, so that the rod antenna 98 passes through. A threaded part 116 is formed in the lower portion of the outer wall. Therefore, it is engaged to the threaded groove 132 of the inner side of the antenna holder 130. An engaging shoulder part 151 is formed in the upper side of the antenna connector 114. The antenna support part 112 and the antenna connector 114 are integrally formed by the insertion injection method and prevents the antenna connection 114 from being idle-rotated in the interior of the antenna support part 112.

A stopper 141 is formed in an outer wall of the antenna connector 114 for limiting the rotation of the antenna connector 114 based on the engagement with the protrusion step 135. The stopper 141 is threaded with the protrusion step 135, so that the antenna connector 114 is not rotated for thereby determining the assembling direction of the antenna housing 110.

In the above described construction, when the antenna holder 130 is engaged to the antenna engaging part 120, the rotation limit surface 126 is tightly inserted into the mounting groove 122 of the antenna engaging part 120, so that the antenna holder 130 is preciously engaged, whereby it is possible to achieve an easier assembling operation. In addition, when the antenna connector 114 is engaged to the antenna holder 130 preciously engaged at the portion of the antenna engaging part 120, the shorter slanted surface of the protrusion step 135 guides the rotation of the antenna connector 114, so that the antenna connector 114 is smoothly and stably engaged with the antenna holder 130.

As described above, in the case that the cross section of the antenna housing is not an elliptical shape, a rectangular shape or a circular shape, the antenna is installed using the thread method. In this case, the antenna housing does not have a good look balance with the body of the cellular phone. Therefore, in the present invention, when the antenna is engaged to the body of the cellular phone, the antenna may be installed always in the same type irrespective of the outer look of the antenna. The antenna is stably fixed to the body of the cellular phone. The disassembling and assembling are easy. An exchanging work is convenient.

Namely, in the present invention, the protrusion part is formed in the antenna connector adapted to support the rod antenna. The protrusion part is inserted into the guide groove part of the antenna holder installed in the body of the cellular phone. In the present invention, it is possible to engage or disengage the antenna to/from the body of the cellular phone by rotating the antenna housing. A stopper is formed in an outer wall of the antenna housing, and a protrusion step is formed in the antenna holder or the mounting groove of the body of the cellular phone engaged with the antenna housing. Therefore, the antenna housing is rotated in the clockwise direction until the stopper is caught by the protrusion step and is stopped, so that the antenna is assembled based on the tight insertion method.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. An antenna for a cellular phone, comprising:
an antenna holder having a guide groove part and engaged in a body of a cellular phone;
an antenna housing that is formed of an antenna connector having a protrusion part engaged to the guide groove part and fixedly inserted into the antenna holder, and an antenna support part integrally formed in the antenna connector; and
a rod antenna that passes through the antenna connector and the antenna support part, respectively, in such a manner that the rod antenna is extendable from the body of the cellular phone.

2. The antenna of claim 1, wherein said antenna holder includes a guide groove part formed of:
an entry groove formed in a hollow cylindrical shape in such a manner that the protrusion is inserted into one side of an upper hole;
an entry straight line groove horizontally extended from the entry groove;
a slant guiding groove downwardly extended from the entry straight line groove; and
a fixed straight line groove horizontally extended from the slant guiding groove.

3. The antenna of claim 2, wherein two guide groove parts are formed in the antenna holder, and two protrusion parts engaged with the guide groove part are formed in the antenna connector.

4. The antenna of claim 1, wherein an elastic protrusion is formed in a lower side of the antenna support part of the antenna housing, and the elastic protrusion part contacts with an outer side of the body of the cellular phone, so that the antenna housing is stably fixed to the body of the cellular phone.

5. The antenna of claim 2, wherein a fixed groove is formed in the fixed straight line groove of the guide groove part of the antenna holder wherein the protrusion part of the antenna connector is fixedly inserted into one of the fixed groove.

6. In an antenna for a cellular phone that includes an antenna housing formed of a metallic antenna connector electrically connected with a transmission and receiving circuit in the interior of a body of a cellular phone and having a vertical through hole in the interior of the body so that a rod antenna is upwardly expendable, and an antenna support part that is formed of a synthetic resin or rubber material and integrally formed in an outer side of the antenna connector by an insert injection method so that a cross sectional shape is line-symmetrical line an elliptical shape or a rectangular shape, an antenna engaging part formed in one side of the upper side of the body so that the antenna housing is engaged to the body of the cellular phone, and a metallic antenna holder installed in a hollow mounting groove formed in the antenna engaging part, an improved antenna for a cellular phone, comprising:
a protrusion step vertically formed in the upper side of the antenna holder at both sides of the same in such a manner that a downwardly slanted groove is formed from one side to the other side or from the other side to one side, wherein the antenna holder is installed in the mounting groove in such a manner that an extension line connecting both protrusion steps is horizontal with respect to the upper surface of the body of the cellular phone; and
a stopper provided at both sides of the outer wall of the antenna connector and engaged with the protrusion step, wherein both ends of the antenna support part are horizontal with respect to the upper surface of the body of the cellular phone and are matched with the upper surface of the antenna engaging part.

7. The antenna of claim 6, wherein the height of the protrusion step is within a range of 0.2 mm through 1 mm.
